(19) United States
(12) Patent Application Publication
(10) Pub. No.: US 2014/0166217 A1
(43) Pub. Date: Jun. 19, 2014

(54) COMBINATION OF ROMAN SHADE AND HONEYCOMB SHADE

(71) Applicant: CHING FENG HOME FASHIONS CO., LTD., Fuxing Shiang (TW)

(72) Inventors: SHENG-YING HSU, Fuxing Shiang (TW); WU-CHUNG NIEN, Fuxing Shiang (TW)

(73) Assignee: CHING FENG HOME FASHIONS CO., LTD., Fuxing Shiang (TW)

(21) Appl. No.: 14/072,614

(22) Filed: Nov. 5, 2013

(30) Foreign Application Priority Data
Dec. 18, 2012 (TW) 101224483

(51) Int. Cl. E06B 9/262

(52) U.S. Cl. CPC E06B 9/262
USPC 160/84.05

(57) ABSTRACT

A honeycomb shade includes multiple honeycomb units connected continuously and each honeycomb unit includes a front part, a rear part and a non-transparent plate. Two elongate sides of the front part are connected to two elongate sides of the rear part, and each of the front and rear parts is folded along the intermediate position thereof to form the honeycomb shade. The non-transparent plate is connected to the inside of the rear part so as to reduce the light transmittance.

### FIELD OF THE INVENTION

The present invention relates to a honeycomb shade, and more particularly, to a non-transparent honeycomb shade.

### BACKGROUND OF THE INVENTION

The conventional honeycomb shade is durable and has multiple colors available so that the honeycomb shade is welcomed in the market. The honeycomb shade includes a hollow space in the shade so that the air in the hollow space isolates the higher outer temperature from entering the interior of the room using the honeycomb shade.

However, the honeycomb shade is made by the material which is partially transparent so that the privacy of the users in the room is concerned. Furthermore, the light transmittance of the honeycomb shade cannot ideally keep the outside light from the interior of the room. The present invention intends to provide a honeycomb shade which has a non-transparent plate connected to each unit of the honeycomb structure so as to effectively improve the shortcomings of the conventional honeycomb shade.

### SUMMARY OF THE INVENTION

The present invention relates to a honeycomb shade and comprises multiple honeycomb units connected continuously and each honeycomb unit has a front part, a rear part and a non-transparent plate. Two elongate sides of the front part are connected to two elongate sides of the rear part. Each of the front and rear parts is folded along the intermediate position thereof to form the honeycomb shade. The non-transparent plate is connected to the inside of the rear part.

The primary object of the present invention is to provide a honeycomb shade which has a non-transparent plate connected to the inside of the rear part of each honeycomb unit so as to keep the outer light from entering the room.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the side view of the machine for manufacturing the honeycomb shade of the present invention;

FIG. 2 is an enlarged view to show a part of the machine for manufacturing the honeycomb shade of the present invention;

FIG. 3 shows the manufacturing steps of the honeycomb shade of the present invention;

FIG. 4A shows the cutting steps of the honeycomb shade of the present invention;

FIG. 4B shows the honeycomb shade of the present invention;

FIG. 5 is a perspective view to show the honeycomb shade of the present invention, and

FIG. 6 shows a side cross sectional view of the honeycomb shade of the present invention.

### DETAILED DESCRIPTION OF THE PREFERRED EMBODIMENT

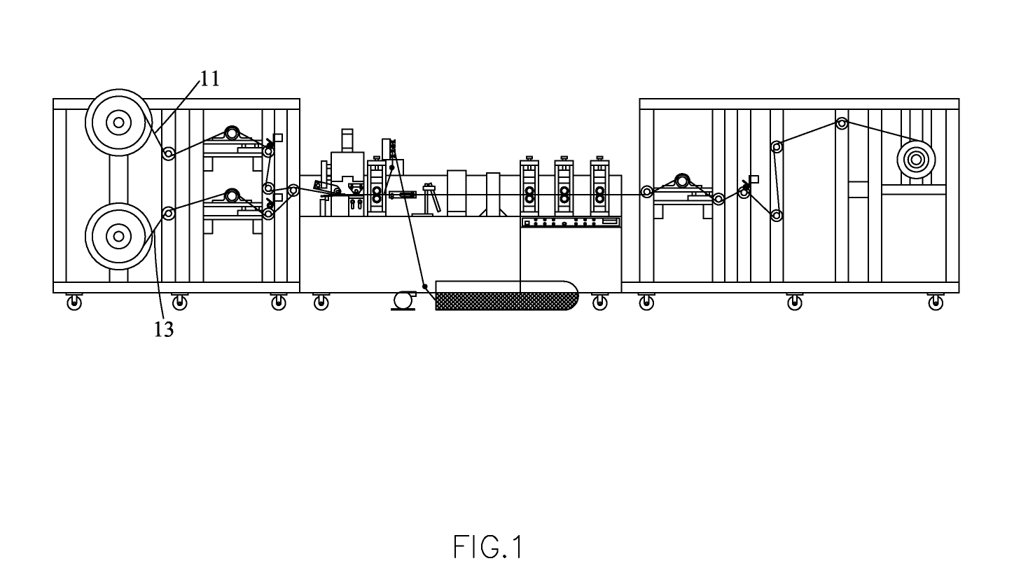

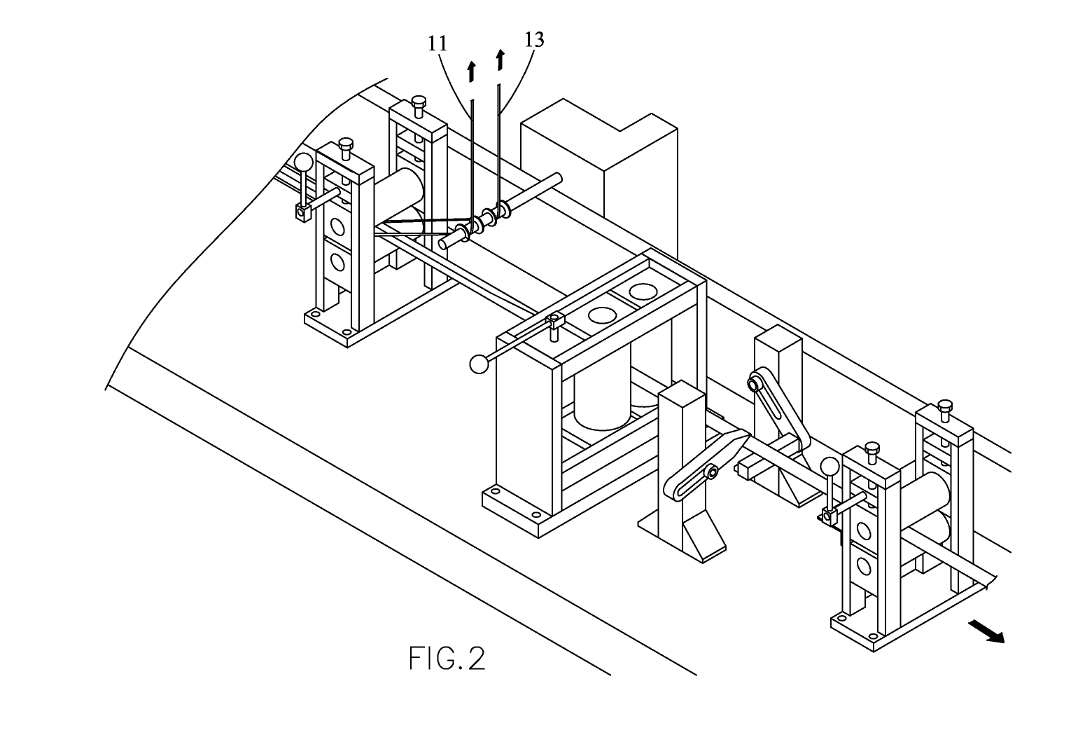

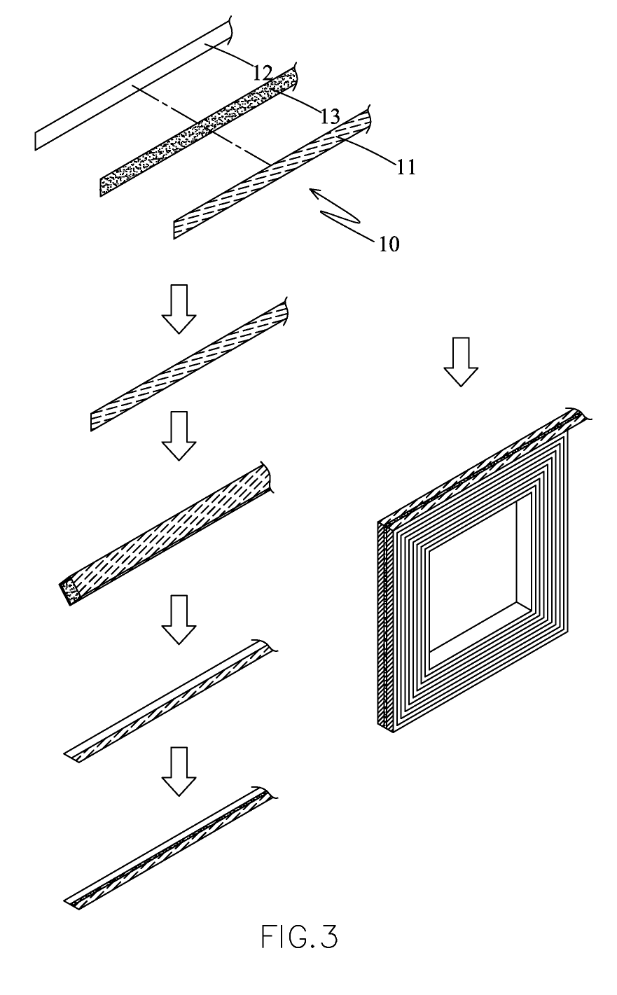

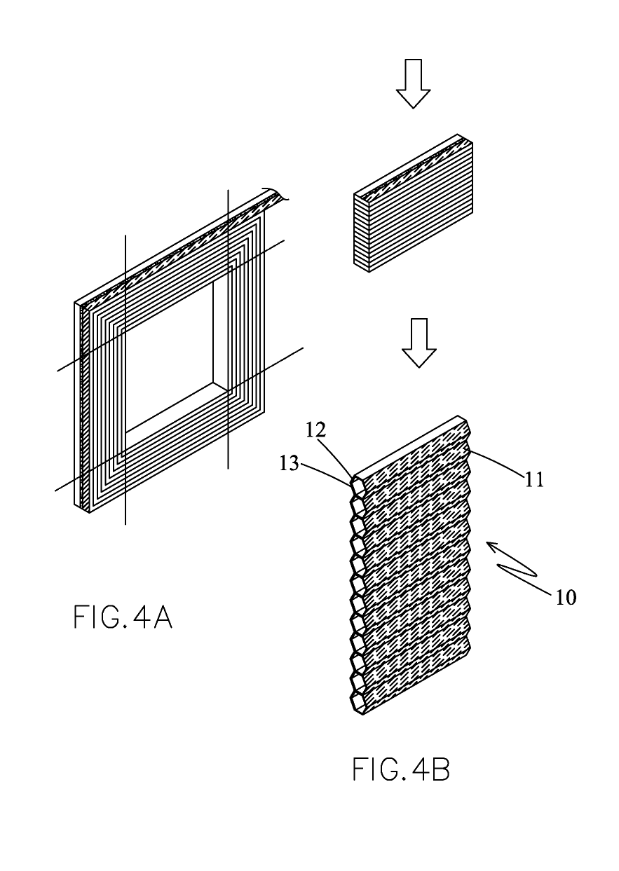

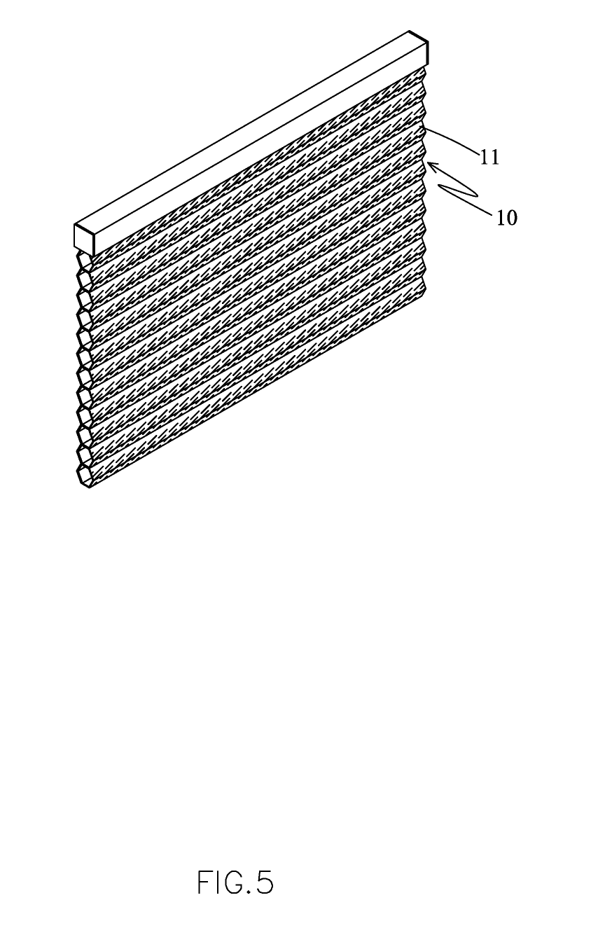

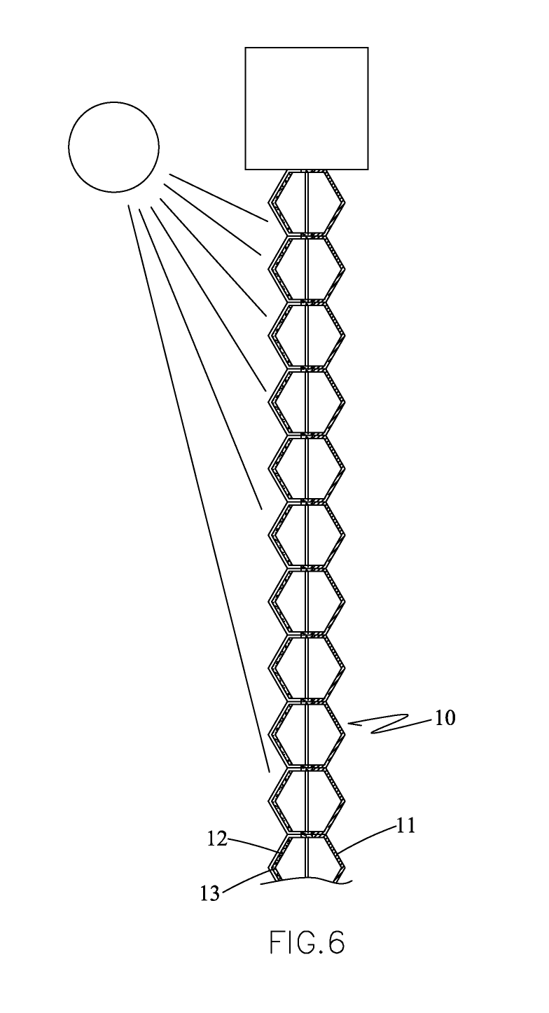

Referring to FIGS. 1 to 6, the honeycomb shade 10 of the present invention comprises a multiple honeycomb units connected continuously and each honeycomb unit comprises a front part 11, a rear part 12 and a non-transparent plate 13. Two elongate sides of the front part 11 are connected to two elongate sides of the rear part 12. Each of the front and rear parts 11, 12 is folded along the intermediate position thereof to form the honeycomb shade. The non-transparent plate 13 is connected to the inside of the rear part 12. The front and rear parts 11, 12 have different colors. The rear parts 12 of the honeycomb shade 10 face outside of the room and the non-transparent plates 13 effectively keep the outside light from entering the room.

The non-transparent plate 13 is made by Aluminum foil which is light in weight and has a very low light transmittance so as to maintain the privacy of the users in the room.

While we have shown and described the embodiment in accordance with the present invention, it should be clear to those skilled in the art that further embodiments may be made without departing from the scope of the present invention.

What is claimed is:

1. A honeycomb shade comprising:
multiple honeycomb units connected continuously and each honeycomb unit having a front part, a rear part and a non-transparent plate, two elongate sides of the front part connected to two elongate sides of the rear part, each of the front and rear parts being folded along an intermediate position thereof to form a honeycomb shade, the non-transparent plate connected to an inside of the rear part.

2. The honeycomb shade as claimed in claim 1, wherein the front and rear parts have different colors.
